(19) United States
(12) Patent Application Publication
(10) Pub. No.: US 2021/0155045 A1
(43) Pub. Date: May 27, 2021

(54) PNEUMATIC TIRE COMPRISING AN IMPROVED ARAMID TEXTILE CORD WITH AN AT LEAST TRIPLE TWIST

(71) Applicant: COMPAGNIE GENERALE DES ETABLISSEMENTS MICHELIN, Clermont-Ferrand (FR)

(72) Inventors: AUGUSTIN BOSQUET, Clermont-Ferrand (FR); RICHARD CORNILLE, Clermont-Ferrand (FR)

(21) Appl. No.: 16/982,248

(22) PCT Filed: Mar. 19, 2019
(86) PCT No.: PCT/FR2019/050617

§ 371 Date: Sep. 18, 2020

(30) Foreign Application Priority Data
Mar. 20, 2018 (FR) 1852370
Mar. 20, 2018 (FR) 1852371

(51) Int. Cl. B60C 9/00; B60C 9/22

(52) U.S. Cl. CPC B60C 9/0042; B60C 9/0064; B60C 2009/2016; B60C 2009/0092; B60C 2009/0078; B60C 9/22

(57) ABSTRACT

The invention relates to a tyre comprising a working reinforcement comprising a single working ply, a carcass reinforcement and a hoop reinforcement. The hooping reinforcing textile filamentary element or elements (480), the working reinforcing filamentary elements (460) and the carcass reinforcing filamentary elements (440) are arranged so as to form a triangular mesh in projection on the circumferential equatorial plane (E). The or each hooping reinforcing textile filamentary element (480) is formed by a cord (30) with a triple twist (T1, T2, T3), comprising an assembly (25) consisting of N>1 strands (20a, 20b, 20c) twisted together with a twist T3 in a direction D2, each strand consisting of M>1 pre-strands, which are themselves twisted together with a twist T2 (T2a, T2b, T2c) in a direction D1 opposite to D2, each pre-strand itself consisting in a yarn that has been previously twisted about itself with a twist T1 in the direction D1, wherein at least half of the N times M yarns consist of elementary monofilaments of aromatic polyamide or aromatic copolyamide.

The present invention relates to textile reinforcing elements or “reinforcers” that can be used for reinforcing vehicle tyres in which the stresses are particularly high as a result of a specific tyre architecture.

Textile has been used as a tyre reinforcer since the very beginning. Textile cords, manufactured from continuous textile fibres such as polyester, nylon, cellulose or aramid fibres, have an important role, as is known, in tyres, including high-performance tyres approved for very high speed running. To meet the requirements of the tyres, they must have a high breaking strength, a high tensile modulus, good fatigue endurance and finally good adhesion to the matrices of rubber or other polymers that they may reinforce.

It will be briefly noted here that these textile plied yarns or cords, conventionally having a double twist (T1, T2), are prepared by what is known as a “twisting” method in which:
in a first step, each constituent multifilament yarn or fibre (“yarn” in English) of the cord is initially twisted individually about itself (with an initial twist T1) in a given direction D1 (the direction S or Z respectively), to form a strand (“strand” in English) in which the elementary filaments are subjected to a helical deformation about the fibre axis (or strand axis);
then, in a second step, a plurality of strands, usually two, three or four in number, of identical kinds or different kinds in the case of cords known as hybrid or composite, are subsequently re-twisted together with a final twist T2 (which may be equal to or different from T1) in an opposite direction D2 (the direction Z or S respectively, according to a recognized terminology designating the orientation of the turns according to the central portion of an S or a Z), to produce the cord (“cord” in English) or final assembly having multiple strands.

The purpose of the twisting is to adapt the properties of the material so as to create the transverse cohesion of the reinforcer, increase its fatigue resistance and also improve adhesion with the reinforced matrix.

Such textile cords, their constructions and methods of manufacture are well known to a person skilled in the art. They have been described in detail in many documents, of which the following are only a few examples: EP 021 485, EP 220 642, EP 225 391, EP 335 588, EP 467 585, U.S. Pat. Nos. 3,419,060, 3,977,172, 4,155,394, 5,558,144, WO97/06294 and EP 848 767, and more recently WO2012/104279, WO2012/146612, WO2014/057082.

In order to be able to reinforce rubber articles such as tyres, the fatigue strength (endurance in tension, bending, compression) of these textile cords is of key importance. It is known that, as a general rule, for a given material, the fatigue strength increases with the amount of twist used, but, on the other hand, the tensile breaking strength (called the toughness when it is related to the unit of weight) decreases inexorably as the twist increases, which is evidently detrimental in terms of reinforcement. Having been manufactured, textile cords are embedded in a polymer matrix, preferably an elastomer matrix, to form a semi-finished article or product comprising the matrix and the textile cords embedded in the matrix. For the purpose of tyre manufacture, the semi-finished article or product takes the general form of a ply.

Therefore the designers of textile cords, as well as tyre manufacturers, are constantly seeking textile cords in which the mechanical properties, particularly the breaking strength and toughness, for a given material and a given twist, are improved.

Thus there is a tyre known from the prior art, and notably from the document WO2016/166056, which comprises a crown comprising a tread, two sidewalls, and two beads, each sidewall connecting each bead to the crown, a crown reinforcement extending in the crown in a circumferential direction of the tyre, the crown reinforcement comprising a hoop reinforcement comprising a single hooping ply comprising at least one filamentary hoop reinforcer element forming an angle that is strictly less than 10° with the circumferential direction of the tyre.

The tyre comprises a carcass reinforcement anchored in each of the beads and extending in the sidewall, the crown reinforcement being radially interposed between the carcass reinforcement and the tread.

The carcass reinforcement comprises a single carcass ply, the single carcass ply comprising carcass reinforcing filamentary elements.

The crown reinforcement comprises a working reinforcement comprising a single working ply, and the single working ply comprises working reinforcing filamentary elements.

In this tyre, the hooping reinforcing textile filamentary element or elements, the working reinforcing filamentary elements and the carcass reinforcing filamentary elements are arranged so as to form a triangular mesh in projection on the circumferential equatorial plane.

In WO2016/166056, because of the elimination of a working ply as compared with tyres comprising two working plies, the hooping ply comprises filamentary textile or metallic hooping reinforcement elements which are of conventional construction but have breaking strength and modulus properties which are all relatively high, in order to compensate for the elimination of one of the working plies as compared with a conventional tyre in which the working reinforcement comprises two working plies. Thus, although such hooping reinforcing filamentary elements provide the mechanical strength properties of the crown, the endurance that they impart to the hoop reinforcement could be improved. This endurance is all the more necessary since, in the case of a crown reinforcement that only comprises a single working ply, the hooping ply is intended to provide the crown reinforcement with a part of the endurance lost by the elimination of one of the working plies.

An object of the invention is a tyre comprising a working reinforcement comprising a single working ply, this tyre having high mechanical properties and improved endurance.

Thus an object of the invention is a tyre comprising a crown comprising a tread, two sidewalls and two beads, each sidewall connecting each bead to the crown, a crown reinforcement extending in the crown in a circumferential direction of the tyre, the crown reinforcement comprising a hoop reinforcement comprising a single hooping ply comprising at least one hooping reinforcing textile filamentary element forming an angle that is strictly less than 10° with the circumferential direction of the tyre, the tyre comprising a carcass reinforcement anchored in each of the beads and extending in the sidewalls and in the crown, the crown reinforcement being radially interposed between the carcass reinforcement and the tread,

the carcass reinforcement comprises a single carcass ply, the single carcass ply comprising carcass reinforcing filamentary elements,
the crown reinforcement comprises a working reinforcement comprising a single working ply, and the single working ply comprises working reinforcing filamentary elements, the hooping reinforcing textile filamentary element or elements, the working reinforcing filamentary elements and the carcass reinforcing filamentary elements are arranged so as to form a triangular mesh in projection on the circumferential equatorial plane, the or each hooping reinforcing textile filamentary element being formed by a triple-twist cord as defined below.

The textile cord or plied yarn of the tyre according to the invention is therefore a cord of very specific construction, the essential characteristics of which are that it has an assembly:
exhibiting a triple twist (that is to say three twists) T1, T2, T3;
the assembly consisting of N>1 strands, which are twisted together in a final twist T3 and a final direction D2 (S or Z);
the assembly consisting of M>1 pre-strands, which are themselves twisted together in an intermediate twist T2 and an intermediate direction D1 (Z or S) opposed to D2 (S or Z);
each pre-strand consisting of a yarn that has previously been twisted about itself according to an initial twist T1 and the initial direction D1 (Z or S).

Half of the N times M yarns consist of elementary monofilaments of aromatic polyamide or aromatic copolyamide.

The invention therefore consists in the use of a hooping ply comprising hooping reinforcing textile filamentary elements having high mechanical properties and endurance making it possible to compensate for the presence of only a single working ply in the working reinforcement.

This is because the claimed triple-twist structure of the hooping reinforcing textile filamentary element makes it possible to obtain, on the one hand, an apparent toughness and, on the other hand, an endurance much greater than those of a conventional hybrid textile filamentary element such as that described in WO2016/166056.

As demonstrated by the comparative tests below, yarns consisting of elementary monofilaments of aromatic polyamide or aromatic copolyamide make it possible to obtain a gain in toughness, in apparent toughness (toughness related to the apparent diameter) and in endurance which is relatively high compared with similar cords using yarns comprising elementary monofilaments of polyester or nylon. The expression “elementary monofilament of aromatic polyamide or aromatic copolyamide” indicates, in a known way, that we are concerned here with an elementary monofilament of linear macromolecules formed by aromatic groups interlinked by amide links, at least 85% of which are directly linked to two aromatic rings, and more particularly by fibres of poly(p-phenylene terephthalamide) (or PPTA), which for a long time have been produced from optically anisotropic spinning compositions. Among aromatic polyamides or aromatic copolyamides, mention may be made of polyarylamides (or PAA, notably known by the Solvay company trade name Ixef), poly(metaxylylene adipamide), polyphthalamides (or PPA, notably known by the Solvay company trade name Amodel), amorphous semiaromatic polyamides (or PA 6-3T, notably known by the Evonik company trade name Trogamid), or para-aramids (or poly(paraphenylene terephthalamide or PA PPD-T notably known by the Du Pont de Nemours company trade name Kevlar or the Teijin company trade name Twaron).

The triple-twist cord of the tyre according to the invention is particularly advantageous because of its excellent endurance in the particularly stressful architecture of the tyre of the invention and its reduced diameter.

Thus, owing to its reduced diameter, the cord makes it possible to reduce the thicknesses of the hooping ply, the weight of the latter, the hysteresis of the tyre, and therefore the rolling resistance of the tyre. In fact, everything else being equal, the hysteresis of the hooping ply increases with its thickness. By reducing the diameter, the total thickness of the ply is reduced, while the thickness present at the rear of each cord is maintained, making it possible to maintain the decoupling thicknesses between the tread and the hooping ply on the one hand, and between the plies radially inside the hooping ply and the hooping ply itself on the other hand. Furthermore, by keeping the thickness at the rear of each cord constant, the resistance to the passage of corrosive agents through the hooping ply is retained, enabling the working reinforcement to be protected, this protection being more important when the working reinforcement comprises only a single working ply.

The tyres of the invention are preferably intended for motor vehicles of the 4×4 SUV (Sport Utility Vehicle) passenger type.

In the present application, unless expressly indicated otherwise, all the percentages (%) shown are percentages by weight.

Any interval of values denoted by the expression “between a and b” represents the range of values extending from more than a to less than b (that is to say, limits a and b excluded), while any interval of values denoted by the expression “from a to b” means the range of values extending from a up to b (that is to say, including the strict limits a and b).

All the aforementioned properties (count, initial modulus of the yarns, breaking strength and toughness) are determined at 20° C. in cords that are raw (that is to say not coated) or adherized (that is to say ready for use or extracted from the article that they reinforce), and that have been subjected to preliminary conditioning; the term “preliminary conditioning” is taken to mean that the cords are stored (after drying) for at least 24 hours, before measurement, in a standard atmosphere according to European Standard DIN EN 20139 (temperature, 20±2° C.; moisture content, 65±2%).

The count (or linear density) of the yarns, pre-strands, strands or cords is determined according to the ASTM D 885/D 885M-10a standard of 2014; the count is given in tex (weight in grams of 1000 m of product−reminder: 0.111 tex is equal to 1 denier).

The mechanical tensile properties (toughness, initial modulus, elongation at break) are measured in a known way, using an Instron tensile machine with 4D tension grips (for a breaking strength of less than 100 daN) or 4E grips (for a breaking strength of at least 100 daN), unless specified otherwise according to the ASTM D 885/D 885M-10a standard of 2014. The samples tested are subjected to a tensile stress over an initial length of 400 mm for the 4D grips and 800 mm for the 4E grips at a nominal speed of 200 mm/min, under a standard pretension of 0.5 cN/tex. All the results given are an average over 10 measurements. When the properties are measured in yarns, the latter undergo, as is well known, a very small preliminary twist, called the “protection twist”, corresponding to a spiral angle of about 6 degrees, before being positioned and subjected to tension in the grips.

As is known to a person skilled in the art, the toughness is the ratio of breaking strength to count, and is expressed in cN/tex. The apparent toughness (in daN/mm²) is the ratio of the breaking strength to the apparent cross section S, where S=(Pi*ø²)/4, and where ø is the apparent diameter, which is measured by the following method.

Use is made of an apparatus which, by means of a receiver composed of a collecting optical system, a photodiode and an amplifier, enables the shadow of a cord illuminated by a laser beam of parallel light to be measured with an accuracy of 0.1 micrometre. Such an apparatus is marketed, for example, by the Z-Mike company, under the reference “1210”. The method consists in fixing a specimen of the cord whose diameter is to be measured to a powered moving table under a standard pre-tension of 0.5 cN/tex, after the cord has undergone preliminary conditioning. When fixed to the moving table, the cord is moved perpendicularly to the drop shadow measurement system at a speed of 25 mm/s, and cuts the laser beam orthogonally. At least 200 drop shadow measurements are made over a length of 420 mm of cord; the mean of these drop shadow measurements represents the apparent diameter ø.

The breaking strength of a ply is calculated on the basis of a force-elongation curve obtained by applying the ASTM D 885/D 885M-10a of 2014 to a cord of the ply. The breaking strength of the ply is determined by multiplying the breaking strength of the cords by the number of cords per mm of ply, this number being determined along a direction perpendicular to the direction in which the cords extend in the ply.

The expression axial direction means the direction substantially parallel to the axis of rotation of the tyre.

The expression circumferential direction means the direction that is substantially perpendicular to both axial direction and a radius of the tyre (in other words, tangent to a circle centred on the axis of rotation of the tyre).

The expression radial direction means the direction along a radius of the tyre, namely any direction that intersects the axis of rotation of the tyre and is substantially perpendicular to that axis.

The expression median plane (denoted M) means the plane perpendicular to the axis of rotation of the tyre that is situated mid-way between the two beads and passes through the middle of the crown reinforcement.

The expression equatorial circumferential plane (denoted E) means the theoretical plane passing through the equator of the tyre, perpendicular to the median plane and to the radial direction. The equator of the tyre is, in a circumferential section plane (plane perpendicular to the circumferential direction and parallel to the radial and axial directions), the axis parallel to the axis of rotation of the tyre and situated equidistantly between the radially outermost point of the tread that is intended to be in contact with the ground and the radially innermost point of the tyre that is intended to be in contact with a support, for example a rim, the distance between these two points being equal to H.

The orientation of an angle means the direction, clockwise or anticlockwise, in which it is necessary to rotate from a reference straight line, in this instance the circumferential direction of the tyre, defining the angle in order to reach the other straight line defining the angle.

The expression cord or assembly having a triple twist (that is to say, three twists), will be immediately understood by a person skilled in the art as meaning that three consecutive operations of untwisting (or reverse twisting) are required to “deconstruct” the cord or assembly of the invention and to “return” to the initial yarns forming it, that is to say to retrieve the original yarns (fibres comprising the elementary monofilaments) in their initial state, that is to say without a twist. In other words, there are exactly three (not two or four) successive twisting operations for forming the cord or assembly of the invention, and not two as is usually the case.

Advantageously, each yarn consists of elementary monofilaments of aromatic polyamide or aromatic copolyamide.

Advantageously, N ranges from 2 to 6, or preferably from 2 to 4.

Advantageously, M ranges from 2 to 6, or preferably from 2 to 4.

In a way which is well known to a person skilled in the art, the twists may be measured and expressed in two different ways, either simply as a number of turns per metre (t;m⁻¹), or more rigorously, when materials differing in their nature (mass per unit volume) and/or their count are to be compared, as a spiral angle, or in the form of a twist factor K which is equivalent.

The twist factor K is related to the twist T (here, for example, T1, T2, T3 respectively) by the following known relation:

K=(Twist T)×[(Count/(1000·ρ)]^{1/2}

in which the twist T of the elementary monofilaments (forming the pre-strand, strand or plied yarn) is expressed in turns per metre, the count is expressed in tex (weight in grams of 1000 metres of pre-strand, strand or plied yarn), and finally p is the density or mass per unit volume (in g/cm3) of the constituent material of the pre-strand, strand or plied yarn (approximately 1.50 g/cm3 for cellulose, 1.44 g/cm3 for aramid, 1.38 g/cm3 fora polyester such as PET, 1.14 g/cm3 for nylon); in the case of a hybrid cord, p is evidently a mean of the densities weighted by the respective counts of the constituent materials of the pre-strands, strands or plied yarns.

Preferably, the twist T1 expressed in turns per metre (t·m⁻¹) ranges from 10 to 350, or more preferably from 20 to 200.

In a preferred embodiment, each pre-strand has a twist factor K1 ranging from 2 to 80, or more preferably from 6 to 70.

According to a preferred embodiment, the twist T2 expressed in turns per metre ranges from 25 to 470, or more preferably from 35 to 400.

According to a preferred embodiment, each strand has a twist factor K2 ranging from 10 to 150, or more preferably from 20 to 130.

According to a preferred embodiment, the twist T3 expressed in turns per metre ranges from 30 to 600, or more preferably from 80 to 500.

According to a preferred embodiment, the cord of the invention has a twist factor K3 ranging from 50 to 500, or more preferably from 80 to 230.

Preferably, T2 is greater than T1 (T1 and T2 being notably expressed in t·m⁻¹).

According to another preferred embodiment, which may or may not be combined with the previous one, T3 is greater than T2 (T2 and T3 being notably expressed in t·m⁻¹), T2 ranging more preferably from 0.2 times T3 to 0.95 times T3, particularly from 0.4 times T3 to 0.8 times T3.

According to a preferred embodiment which enables the endurance to be improved even further, the sum T1+T2 ranges from 0.8 times T3 to 1.2 times T3, or more preferably from 0.9 times T3 to 1.1 times T3 (T1, T2 and T3 being notably expressed in t·m⁻¹), T1+T2 being, in particular, preferably equal to T3.

In a first preferred variant, each yarn has a count varying from 45 to 65 tex, preferably from 50 to 60 tex, and more preferably each fibre has a count equal to 55 tex. In this first preferred variant, preferably, N=3 and M=3. Such a combination of count, number of strands and pre-strands enables the endurance in flexion and compression to be maximized while containing the diameter of the cord, the enlargement of which would be undesirable, since such enlargement would inevitably lead to a thickening of the hoop reinforcement, in spite of a satisfactory apparent toughness of the textile cord. Additionally, the manufacture of this cord requires no major modifications of the existing twisting machinery. This is because the existing twisting machinery can easily twist 2 or 3 strands or pre-strands together, whereas the twisting of 4 or more strands or pre-strands would require the modification of the whole machinery, that is to say the feed means as well as the twisting means. Such modifications would be costly and would also require the stoppage of the existing machinery. Finally, such a cord requires 9 yarns and therefore 9 steps of pre-strand manufacture, which is relatively short, or does not require the use of numerous twisting machines simultaneously, by comparison with other triple twist cords.

In this first variant, the twist T1 expressed in turns per metre (t·m⁻¹) advantageously ranges from 125 to 165.

In this first variant, each pre-strand has a twist factor K1 that advantageously ranges from 24 to 28.

In this first variant, the twist T2 expressed in turns per metre advantageously ranges from 190 to 210.

In this first variant, each strand has a twist factor K2 that advantageously ranges from 62 to 69.

In this first variant, the twist T3 expressed in turns per metre advantageously ranges from 310 to 370.

In this first variant, the cord has a twist factor K3 that advantageously ranges from 170 to 210.

In this first variant, the cord has a high apparent toughness, which is here advantageously greater than or equal to 140 daN·mm⁻², or preferably greater than or equal to 150 daN·mm⁻²

In this first variant, in a highly advantageous manner, the cord has a relatively small diameter, which is here advantageously less than or equal to 0.95 mm, or preferably less than or equal to 0.90 mm and more preferably less than or equal to 0.86 mm.

In a second preferred variant, each yarn has a count varying from 90 to 130 tex, preferably from 100 to 120 tex, and more preferably each fibre has a count equal to 110 tex. In this first preferred variant, preferably, N=3 and M=2. Such a combination of count, number of strands and pre-strands enables the endurance in flexion and compression to be maximized while containing the diameter of the cord, the enlargement of which would be undesirable, since such enlargement would inevitably lead to a thickening of the hoop reinforcement, in spite of a satisfactory apparent toughness of the textile cord. Additionally, the manufacture of this cord requires no major modifications of the existing twisting machinery. This is because the existing twisting machinery can easily twist 2 or 3 strands or pre-strands together, whereas the twisting of 4 or more strands or pre-strands would require the modification of the whole machinery, that is to say the feed means as well as the twisting means. Such modifications would be costly and would also require the stoppage of the existing machinery. Finally, such a cord requires 6 yarns and therefore 6 steps of pre-strand manufacture, which is relatively short, or does not require the use of numerous twisting machines simultaneously, by comparison with other triple twist cords.

In this second variant, the twist T1 expressed in turns per metre (t·m⁻¹) advantageously ranges from 105 to 135.

In this second variant, each pre-strand has a twist factor K1 that advantageously ranges from 30 to 40.

In this second variant, the twist T2 expressed in turns per metre advantageously ranges from 170 to 190.

In this second variant, each strand has a twist factor K2 that advantageously ranges from 69 to 86.

In this second variant, the twist T3 expressed in turns per metre advantageously ranges from 280 to 330.

In this second variant, the cord has a twist factor K3 that advantageously ranges from 170 to 210.

In this second variant, the cord has a high apparent toughness, which is here advantageously greater than or equal to 115 daN·mm⁻², or preferably greater than or equal to 130 daN·mm⁻².

In this second variant, in a highly advantageous manner, the cord has a relatively small diameter, which is here advantageously less than or equal to 1.03 mm, or preferably less than or equal to 1.00 mm and more preferably less than or equal to 0.98 mm.

According to the invention, the hoop reinforcement comprises a single hooping ply. Thus, the hoop reinforcement, apart from the hooping ply, does not have any ply reinforced by filamentary reinforcing elements. The filamentary reinforcing elements of such reinforced plies excluded from the hoop reinforcement of the tyre comprise the metal filamentary reinforcing elements and the textile filamentary reinforcing elements. Very preferentially, the hoop reinforcement is formed by a hooping ply.

In preferred embodiments, the or each hooping reinforcing textile filamentary element forms an angle smaller than or equal to 7°, and more preferably smaller than or equal to 5°, with the circumferential direction of the tyre.

According to the invention, the carcass reinforcement comprises a single carcass ply. Thus, the carcass reinforcement, apart from the carcass ply, does not have any ply reinforced by filamentary reinforcing elements. The filamentary reinforcing elements of such reinforced plies excluded from the carcass reinforcement of the tyre comprise the metal filamentary reinforcing elements and the textile filamentary reinforcing elements. Very preferably, the carcass reinforcement is formed by a carcass ply.

Advantageously, the carcass reinforcing filamentary elements are anchored in each bead and extend from one to the other bead of the tyre, passing through each sidewall and the crown.

In one embodiment, each carcass reinforcing filamentary element forms an angle AC₁ greater than or equal to 55°, preferably ranging from 55° to 80° and more preferably from 60° to 70°, with the circumferential direction of the tyre in the median plane of the tyre. Thus, the carcass reinforcing filamentary elements, on account of the angle formed with the circumferential direction, are involved in the formation of a triangle mesh in the crown of the tyre.

In one embodiment, each carcass reinforcing filamentary element makes an angle A_{C2} greater than or equal to 85° with the circumferential direction of the tyre in the equatorial circumferential plane of the tyre. The carcass reinforcing filamentary elements are substantially radial in each sidewall, that is to say substantially perpendicular to the circumferential direction, enabling all the advantages of a radial carcass tyre to be retained.

According to the invention, the crown reinforcement comprises a working reinforcement comprising a single working ply. Thus, the working reinforcement, apart from the working ply, does not have any ply reinforced by filamentary reinforcing elements. The filamentary reinforcing elements of such reinforced plies excluded from the working reinforcement of the tyre comprise the metal filamentary reinforcing elements and the textile filamentary reinforcing elements. Very preferably, the working reinforcement is formed by a working ply. As explained above, the hoop reinforcement endurance properties imparted by the cord advantageously enable one working ply of the working reinforcement to be eliminated, by comparison with a conventional tyre in which the working reinforcement comprises two working plies. A significantly lighter tyre is obtained.

In the tyre described, the crown comprises the tread and the crown reinforcement. The tread is understood to be a strip of polymeric, preferably elastomeric, material delimited:
radially towards the outside by a surface intended to be in contact with the ground and
radially towards the inside by the crown reinforcement.

The strip of polymeric material is formed by a ply of a polymeric material, preferably is elastomeric or consisting of a stack of a number of plies, each ply consisting of a polymeric, preferably elastomeric, material.

According to the invention, the crown reinforcement comprises a hoop reinforcement and a single working ply. Thus, the crown reinforcement, apart from the hoop reinforcement and the working reinforcement, does not have any reinforcement reinforced by reinforcing elements. The reinforcing elements of such reinforcements excluded from the crown reinforcement of the tyre comprise metallic filamentary reinforcing elements and textile filamentary reinforcing elements. Very preferably, the crown reinforcement is made up of the hoop reinforcement and the working reinforcement.

In a very preferred embodiment, the crown, apart from the crown reinforcement, does not have any reinforcement reinforced by reinforcing elements. The reinforcing elements of such reinforcements excluded from the crown of the tyre comprise metallic filamentary reinforcing elements and textile filamentary reinforcing elements. Very preferably, the crown is made up of the tread and the crown reinforcement.

In a very preferred embodiment, the carcass reinforcement is arranged so as to be directly radially in contact with the crown reinforcement and the crown reinforcement is arranged so as to be directly radially in contact with the tread. In this very preferred embodiment, the single hooping ply and the single working ply are advantageously arranged so as to be directly radially in contact with one another.

The expression directly radially in contact means that the objects in question that are directly radially in contact with one another, in this case the plies, reinforcements or the tread, are not separated radially by any object, for example by any ply, reinforcement or strip interposed radially between the objects in question that are directly radially in contact with one another.

In a preferred embodiment, the hoop reinforcement is radially interposed between the working reinforcement and the tread.

Advantageously, the single working ply being axially delimited by two axial edges, each axial edge being arranged radially outside each sidewall, the working reinforcing filamentary elements extend from one axial edge to the other axial edge of the single working ply.

In one embodiment, each working reinforcing filamentary element makes an angle A_{T} greater than or equal to 10°, preferably ranging from 30° to 50° and more preferably from 35° to 45°, with the circumferential direction of the tyre in the median plane of the tyre. Thus the working reinforcing filamentary elements, because of the angle formed with the circumferential direction, participate in the formation of a triangular mesh in the crown of the tyre.

According to the invention, the hooping reinforcing textile filamentary element or elements, the working reinforcing filamentary elements and the carcass reinforcing filamentary elements are arranged so as to form a triangular mesh in projection on the circumferential equatorial plane. Such a mesh makes it possible to obtain a mechanical behaviour similar to that of a conventional prior art tyre comprising a hooping ply, two working plies and a carcass ply.

In order to form the most effective triangular mesh possible, the orientation of the angle A_{T} and the orientation of the angle A_{C1} are preferably opposite to the circumferential direction of the tyre.

Advantageously, the reinforcing filamentary elements of each ply are embedded in an elastomeric matrix. The different plies may comprise the same elastomeric matrix or different elastomeric matrices.

An elastomeric matrix is understood to be a matrix that exhibits elastomeric behaviour in the crosslinked state. Such a matrix is advantageously obtained by crosslinking a composition comprising at least one elastomer and at least one other component. Preferably, the composition comprising at least one elastomer and at least one other component comprises an elastomer, a crosslinking system, and a filler. The compositions used for these plies are conventional compositions for calendering reinforcers, typically based on natural rubber or other diene elastomer, a reinforcing filler such as carbon black, a curing system and the usual additives. The adhesion between the cord of the invention and the matrix in which it is embedded is provided, for example, by an ordinary adhesive compound, such as an RFL or equivalent adhesive.

Advantageously, each working reinforcing filamentary element is metallic. A metallic filamentary element means, by definition, a filamentary element formed of one thread or an assembly of several threads made entirely (100% of the threads) of a metallic material. Such a metallic filamentary element is preferably implemented with one or more threads made of steel, more preferably of pearlitic (or ferritic-pearlitic) carbon steel referred to as “carbon steel” below, or made of stainless steel (by definition steel comprising at least 11% chromium and at least 50% iron). However, it is of course possible to use other steels or other alloys. If a carbon steel is advantageously used, its carbon content (% by weight of steel) preferably ranges from 0.2% to 1.2%, notably from 0.5% to 1.1%; these contents represent a good compromise between the mechanical properties required for the tyre and the feasibility of the threads. The metal or the steel used, whether it is in particular a carbon steel or a stainless steel, may itself be coated with a metallic layer which improves for example the workability of the metallic cord and/or of its constituent elements, or the use properties of the cord and/or of the tyre themselves, such as properties of adhesion, corrosion resistance or resistance to ageing. According to a preferred embodiment, the steel used is covered with a layer of brass (Zn—Cu alloy) or of zinc.

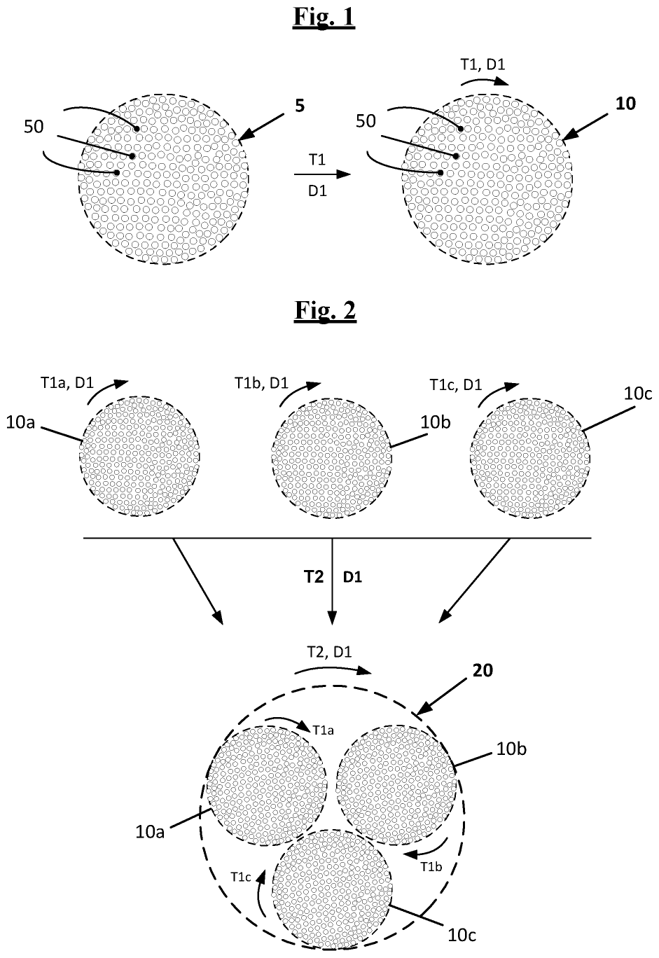

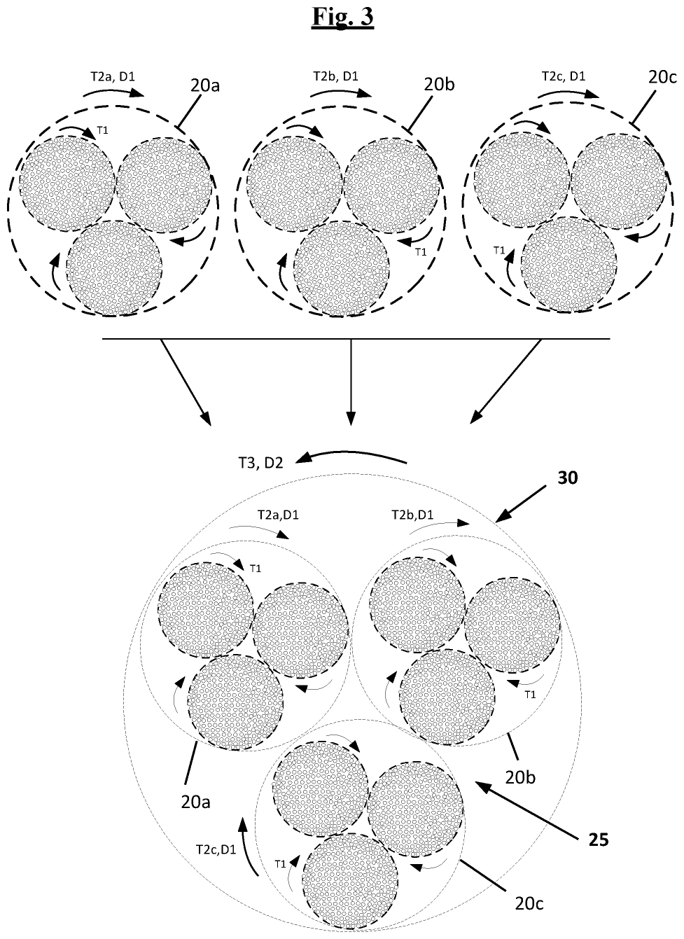

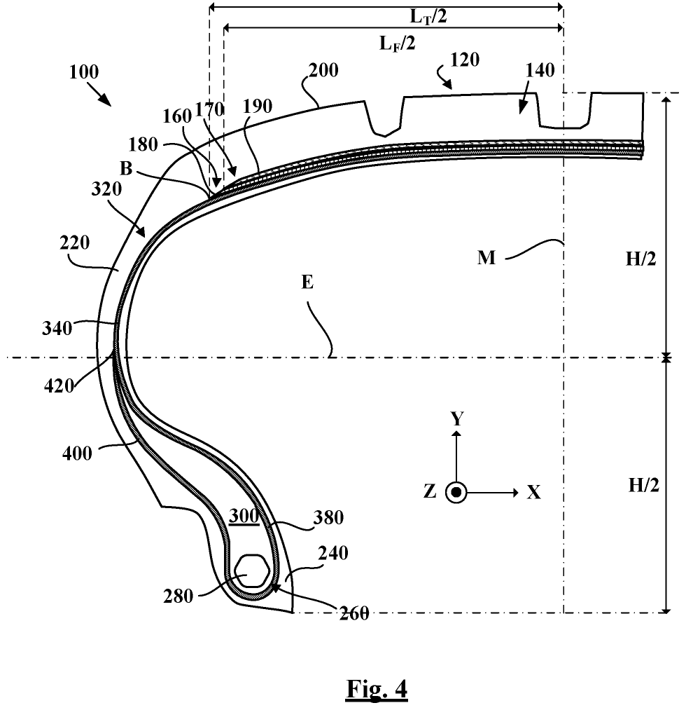

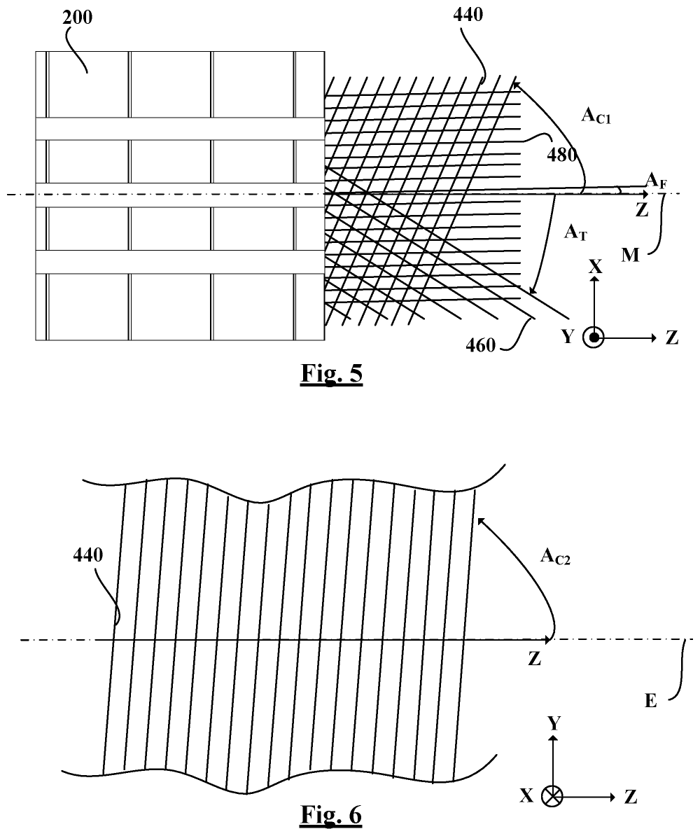

The invention and its advantages will be readily understood in the light of the detailed description and the non-limiting examples of embodiment that follow, and of FIGS. 1 to 6, relating to these examples, which show schematically (without being to any specific scale unless indicated otherwise):
in cross section, a conventional multifilament textile fibre (or yarn), firstly in the initial state (5), that is to say with no twist, and then after a first operation of twisting T1 in the direction D1 to form a yarn twisted about itself, or a “pre-strand” (10) (FIG. 1);
in cross section, the assembly of 3 yarns (10a, 10b, 10c) as above, acting as pre-strands (previously twisted according to T1a, T1b, T1c in the same direction D1), which are assembled by a second operation of twisting T2, still in the same direction D1, to form a strand (20) intended for the cord according to the invention (FIG. 2);
in cross section, the assembly (25) of 3 strands (20a, 20b, 20c) as above (previously twisted according to T2a, T2b, T2c in the same direction D1), which are assembled by a third operation of twisting T3, this time in the direction D2 opposite to the direction D1, to form a triple-twist (T1, T2, T3) cord (30) according to the invention (FIG. 3);
a view in a section perpendicular to the circumferential direction of a tyre according to the invention (FIG. 4);
a cut-away view of the tyre of FIG. 4, showing the projection on to the circumferential equatorial plane E of the hooping reinforcing filamentary elements, the working reinforcing filamentary elements and the carcass reinforcing filamentary elements (FIG. 5);
a view of the carcass reinforcing filamentary elements arranged in the sidewall of the tyre of FIG. 4 in projection on the median plane M of the tyre (FIG. 6).

Firstly, FIG. 1 shows schematically, in cross section, a conventional multifilament textile fibre 5, also called a “yarn” (“yarn” in English), in the initial state, that is to say without any twist; in a well-known way, such a yarn is formed by a plurality of elementary monofilaments 50, typically ranging from several tens to several hundreds, having a very fine diameter which is usually less than 25 μm. Here, each yarn 5 is formed by elementary monofilaments of aromatic polyamide or aromatic copolyamide, and has a count varying from 45 to 65 tex, preferably from 50 to 60 tex, and more preferably equal to 55 tex.

During a first twist operation T1 (first twist), expressed in turns per metre, ranging from 10 to 350 turns·m⁻¹, preferably from 20 to 200 turns·m⁻¹ and more preferably from 125 to 165 turns·m⁻¹, and here equal to 140 turns·m⁻¹, in direction D1 (here Z), the initial fibre 5 is converted into a fibre twisted about itself, called a “pre-strand” 10. In this pre-strand 10, the elementary monofilaments 50 are thus subjected to a spiral deformation about the fibre axis (or the strand axis).

As shown in FIG. 2, each of the M=3 pre-strands 10a, 10b, 10c is characterized by a specific first twist T1 (here, for example, T1a, T1b, T1c) which may be equal (in the general case, that is to say that here, for example, T1a=T1b=T1c) or different from one strand to another. Here, each of the M=3 pre-strands 10a, 10b, 10c has a twist factor K1 ranging from 2 to 80, preferably from 6 to 70, and more preferably from 24 to 28, and here equal to 27.

Then, again with reference to FIG. 2, the M=3 pre-strands 10a, 10b, 10c are themselves twisted together in the same direction D1 (here, Z) as before, with an intermediate twist T2 (second twist) ranging from 25 to 470 turns·m⁻¹, preferably from 35 to 400 turns·m⁻¹ and more preferably from 190 to 210 turns·m⁻¹, and here equal to 200 turns·m⁻¹, to form a “strand” 20.

As shown in FIG. 3, each of the N=3 strands 20a, 20b, 20c is characterized by a specific second twist T2 (here, for example, T2a, T2b, T2c) which may be equal (in the general case, that is to say that here, for example, T2a=T2b=T2c) or different from one strand to another. Here, each of the N=3 strands 20a, 20b, 20c has a twist factor K2 ranging from 10 to 150, preferably from 20 to 130, and more preferably from 62 to 69, and here equal to 68. It should be noted that T2=200 turns·m⁻¹ is greater than T1=100 turns·m⁻¹.

Then, again with reference to FIG. 3, the N=3 pre-strands 20a, 20b, 20c are themselves twisted together in the direction D2, opposite to D1 (here, S), with a final twist T3 (third twist) ranging from 30 to 600 turns·m⁻¹, preferably from 80 to 500 turns·m⁻¹ and more preferably from 310 to 370 turns·m⁻¹, and here equal to 340 turns·m⁻¹, to form the assembly 25 of the cord 30 according to the invention. The cord 30 then has a twist factor K3 ranging from 50 to 500, preferably from 80 to 230, and here equal to 199.

It should be noted that T3=340 turns·m⁻¹ is greater than T2=200 turns·m⁻¹. Additionally, T2 ranges from 0.2 times T3 to 0.95 times T3, preferably from 0.4 times T3 to 0.8 times T3. Here, T2=0.59 times T3.

Additionally, the sum T1+T2 ranges from 0.8 times T3 to 1.2 times T3, preferably from 0.9 times T3 to 1.1 times T3, and here T1+T2=T3.

In a first embodiment, the cord 30 is formed by the raw assembly 25. This is known as a raw cord. A raw cord is such that the constituent elementary monofilaments of the cord result from the method of manufacturing the cord without the elementary monofilaments being covered by any coating having an adhesive function. Thus a raw cord may be bare, that is to say the constituent material or materials of the cord are not coated with any coating, or may be sized, that is to say coated with a sizing compound having the function, notably, of facilitating the sliding of the constituent material or materials of the cord during the process of its manufacture and preventing the accumulation of electrostatic charges.

In a second embodiment, the cord 30 comprises the assembly 25 and an outer layer of an adhesive compound. This is known as an adherized cord. Thus, after the manufacture of the raw assembly 25, the raw assembly 25 is coated with an outer layer of a thermo-crosslinked compound and the raw assembly 25 coated with the outer layer is heat-treated so as to crosslink the adhesive compound to produce the adherized assembly 25, which then forms the cord 30.

In a third embodiment, the cord 30 comprises the assembly 25 and two layers of adhesive compounds. Thus, after the manufacture of the raw assembly 25, the raw assembly 25 is coated with an intermediate layer of a first thermo-crosslinked adhesive compound, and the raw assembly 25 coated with the intermediate layer is heat-treated so as to crosslink the first adhesive compound to produce a pre-adherized assembly 25. The pre-adherized assembly 25 is then coated with an outer layer of a second thermo-crosslinked adhesive compound and the pre-adherized assembly 25 coated with the outer layer is heat-treated so as to crosslink the second adhesive compound to produce the adherized assembly 25, which then forms the cord 30.

The cord 30 has an apparent toughness which is greater than or equal to 140 daN·mm⁻², or preferably greater than or equal to 150 daN·mm⁻², and here equal to 157 daN·mm⁻². The cord 30 has a diameter which is less than or equal to 0.95 mm, or preferably less than or equal to 0.90 mm and more preferably less than or equal to 0.86 mm, and here equal to 0.84 mm.

FIGS. 4 to 6 show a reference frame X, Y, Z corresponding to the usual axial (X), radial (Y) and circumferential (Z) directions, respectively, of a tyre.

FIG. 4 shows a tyre according to the invention and denoted by the general reference 100. The tyre 100 substantially exhibits revolution about an axis substantially parallel to the axial direction X. The tyre 100 is in this case intended for a passenger vehicle.

The tyre 100 has a crown 120 comprising a tread 200 and a crown reinforcement 140 extending in the crown 120 in the circumferential direction Z.

The crown reinforcement 140 comprises a working reinforcement 160 comprising a single working ply 180 and a hoop reinforcement 170 comprising a single hooping ply 190. Here, the working reinforcement 160 consists of the working ply 180 and the hoop reinforcement 170 consists of the hooping ply 190.

The crown reinforcement 140 is surmounted by the tread 200. Here, the hoop reinforcement 170, in this case the hooping ply 190, is radially interposed between the working reinforcement 160 and the tread 200.

The tyre 100 comprises two sidewalls 220 extending the crown 120 radially inwards. The tyre 100 also comprises two beads 240 that are radially on the inside of the sidewalls 220 and each comprise an annular reinforcing structure 260, in this instance a bead wire 280, surmounted by a mass of filling rubber 300, and also a radial carcass reinforcement 320. The crown reinforcement 140 is situated radially between the carcass reinforcement 320 and the tread 200. Each sidewall 220 connects each bead 240 to the crown 120.

The carcass reinforcement 320 has a single carcass ply 340. The carcass reinforcement 320 is anchored in each of the beads 240 by being turned up around the bead wire 280 so as to form, within each bead 240, a main strand 380 extending from the beads 240 through the sidewalls 220 and into the crown 120, and a turnup strand 400, the radially outer end 420 of the turnup strand 400 being radially on the outside of the annular reinforcing structure 260. The carcass reinforcement 320 thus extends from the beads 240 through the sidewalls 220 as far as into the crown 120. In this embodiment, the carcass reinforcement 320 also extends axially through the crown 120. The crown reinforcement 140 is radially interposed between the carcass reinforcement 320 and the tread 200.

Each working ply 180, hooping ply 190 and carcass ply 340 comprises an elastomeric matrix in which one or more reinforcing elements of the corresponding ply are embedded.

With reference to FIG. 5, the single carcass ply 340 comprises carcass reinforcing filamentary elements 440 anchored in each bead 240 and extending from one to the other bead of the tyre 100, passing through each sidewall 220 and the crown 120. Each carcass reinforcing filamentary element 440 forms an angle A_{C1} greater than or equal to 55°, preferably ranging from 55° to 80° and more preferably from 60° to 70°, with the circumferential direction Z of the tyre 100 in the median plane M of the tyre 100, in other words in the crown 120.

With reference to FIG. 6, which is a simplified view in which, given the scale, all the carcass reinforcing filamentary elements 440 are shown parallel to one another, each carcass reinforcing filamentary element 440 makes an angle Au greater than or equal to 85° with the circumferential direction Z of the tyre 100 in the equatorial circumferential plane E of the tyre 100, in other words in each sidewall 220.

In this example, it is adopted by convention that an angle oriented in the anticlockwise direction from the reference straight line, in this case the circumferential direction Z, has a positive sign and that an angle oriented in the clockwise direction from the reference straight line, in this case the circumferential direction Z, has a negative sign. In this instance, A_{C1}=+67° and A_{C2}=+90°.

With reference to FIG. 5, the single working ply 180 comprises working reinforcing filamentary elements 460. The single working ply being axially delimited by two axial edges B, axially defining the width L_{T} of the working ply 180, each axial edge B is arranged radially outside each sidewall 220. The working reinforcing filamentary elements 460 extend from one axial edge B to the other axial edge B of the single working ply 180.

Each carcass reinforcing filamentary element 460 forms an angle A_{T} greater than or equal to 10°, preferably ranging from 30° to 50° and more preferably from 35° to 45°, with the circumferential direction Z of the tyre 100 in the median plane M. Given the orientation defined above, A_{T}=−40°.

The single hooping ply 190 comprises at least one hooping reinforcing textile filamentary element 480. In this instance, the hooping ply 190 comprises a single hooping reinforcing textile filamentary element 480 wound continuously over an axial width L_{F} of the crown 120 of the tyre 100. Advantageously, the axial width L_{F} is less than the width L_{T} of the working ply 180. The hooping reinforcing textile filamentary element 480 forms an angle A_{F} strictly smaller than 10° with the circumferential direction Z of the tyre 100, preferably smaller than or equal to 7°, and more preferably smaller than or equal to 5°. In this instance, A_{F}=+5°.

Note that the carcass reinforcing filamentary elements 440, working reinforcing filamentary elements 460 and hooping reinforcing filamentary elements 480 are arranged, in the crown 120, so as to define, in projection onto the equatorial circumferential plane E, a triangle mesh. Here, the angle A_{F}, and the fact that the orientation of the angle A_{T} and the orientation of the angle A_{C1} are opposite to the circumferential direction Z of the tyre 100, enable this triangular mesh to be obtained.

Each carcass reinforcing filamentary element 440 conventionally comprises two multifilament strands, each multifilament strand consisting of a yarn of polyester monofilaments, here PET, these two multifilament strands being overtwisted individually to 240 turns·m-1 in one direction and then twisted together to 240 turns·m-1 in the opposite direction. These two multifilament strands are wound in a helix around one another. Each of these multifilament strands has a count equal to 220 tex.

Each working reinforcing filamentary element 460 is an assembly of two steel monofilaments that each have a diameter equal to 0.30 mm, the two steel monofilaments being wound together at a pitch of 14 mm.

The hooping reinforcing textile filamentary element 480 is formed by the cord 30 according to the invention described previously.

The tyre 100 is manufactured using the below-described method.

Firstly, the working ply 180 and the carcass ply 340 are manufactured by arranging the reinforcing filamentary elements of each ply parallel to one another and embedding them, by calendering for example, in an uncrosslinked compound comprising at least an elastomer, the compound being intended to form an elastomeric matrix when crosslinked. A ply called a straight ply is obtained, in which the reinforcing filamentary elements of the ply are parallel to one another and are parallel to the main direction of the ply. Then, if necessary, portions of each straight ply are cut off at a cutting angle and these portions are abutted against one another so as to obtain what is called an angle ply, in which the reinforcing filamentary elements of the ply are parallel to one another and form an angle with the main direction of the ply equal to the cut-off angle.

Then, an assembly method as described in EP1623819 or in FR1413102 is implemented.

During this assembly method, the hoop reinforcement 170, in this case the hooping ply 190, is arranged radially on the outside of the working reinforcement 160. In this case, in a first variant, a bead of width B significantly less than L_{F} is manufactured, in which the hooping reinforcing textile filamentary element 480 formed by the cord 30 according to the invention is embedded in an uncrosslinked compound, and the bead is rolled up helically for several turns to obtain the axial width L_{F}. In a second variant, the hooping ply 190 having a width L_{F} is manufactured in a similar manner to the carcass and working plies and the hooping ply 190 is wound through one turn over the working reinforcement 160. In a third variant, the hooping reinforcing textile filamentary element 480 formed by the cord 30 according to the invention is rolled up radially outside the working ply 180, and then a layer of a compound, in which the hooping reinforcing textile filamentary element 480 formed by the cord 30 according to the invention during the curing of the tyre will be embedded, is deposited thereon. In all three variants, the adherized reinforcing textile filamentary element 480 formed by the cord 30 is embedded in a compound to form, on completion of the tyre manufacturing method, the hooping ply 190, comprising the hooping reinforcing textile filamentary element 480 formed by the cord 30 according to the invention.

After a step of laying the tread 200, the tyre is then obtained, in which the compositions of the elastomeric matrices are not yet crosslinked and are in an uncured state. This is what is known as a green form of the tyre.

Finally, the compositions are crosslinked, for example by curing or vulcanization, in order to obtain the tyre in which the compositions are in a crosslinked state. During this curing step, the tyre of which the elastomeric matrices are in the uncured state is expanded radially, circumferentially and axially, for example by pressurizing an inflating membrane, so as to press the tyre against the surfaces of a curing mould.

Comparative Tests

Two series of comparative tests were conducted.

In a first series of tests, cords of known construction and triple-twist cords of the tyre according to the invention were compared in order to demonstrate the notably improved tensile and endurance properties.

In a second series of tests, triple-twist cords of the tyre according to the invention were compared in order to optimize the endurance in flexion and compression, while limiting the modifications to be made to the existing twisting machinery.

First Series of Tests

Tensile Tests

Because of their special construction, the cords of the invention have notably improved tensile properties, as demonstrated by the following examples of embodiment.

Five different tensile tests (Tests 1 to 5) were conducted with the manufacture of a total of 11 cords having different constructions, some but not all according to the invention, based on aliphatic polyamide, aromatic polyamide or aromatic copolyamide.

The nature of each cord example (“T” for control, “C” for comparison and “I” for “according to the invention”), the material used (“N” for aliphatic polyamide, in this case nylon, and “A” for aromatic polyamide, in this case aramid), its construction and its final properties are summarized in the appended Table 1.

The initial yarns are, as is known, available commercially, for example the nylon sold by Kordsa under the trade name T728, or by PHP under the trade names Enka 140HRT or Enka 444HRST, or the aramid sold by DuPont under the trade name Kevlar or by Teijin under the trade name Twaron.

As explained above, the toughness is the ratio of breaking strength to count, and is expressed in cN/tex. The apparent toughness (in daN/mm²) is also shown; in this case, the breaking strength is related to the apparent diameter, denoted Ø, which is measured by the following method.

For each test, the breaking strength, the toughness and the apparent toughness were also shown in relative values, the base of 100 being used for the control cord in each of the five tests.

The control cords (denoted “T” in Table 1) are all characterized by a conventional construction with a double twist T1, T2; the other cords (comparison cords, some but not all according to the invention) are all characterized by a non-conventional construction with a triple twist T1, T2, T3. Only the cords C8, C9 and C11 are according to the invention and combine the characteristic of triple twist with the fact that they consist of yarns consisting of elementary monofilaments of aromatic polyamide or aromatic copolyamide.

To assist with the reading of Table 1, it should be noted here that, for example, the construction denoted “N47/-/3/4” of the control cord C1 signifies that this cord is a double-twist (T1, T2) cord produced simply by an operation of twisting (T2, D2 or S) of 4 different strands, each of which has been prepared in advance by an individual operation of reverse twisting (T1, D1 or Z) of 3 nylon (N) yarns with a count of 47 tex.

The construction denoted “N47/1/3/4” of the cord C2 signifies that this cord is a triple-twist (T1, T2, T3) cord produced by an operation of final twisting (T3, D2 or S) of 4 different strands, each of which has been prepared in advance by an operation of intermediate twisting (T2) in the reverse direction (D1 or Z) of 3 pre-strands, each of these 3 pre-strands consisting of a 1 single nylon (N) yarn with a count of 47 tex, which has previously been twisted about itself in a first twisting operation T1 in the same direction (D1 or Z) as for the pre-strands.

The 5 examples of control cords (“T”) C1, C3, C5, C7 and C10 are all characterized by a double-twist construction; they were manufactured by the assembly of 2, 3 or 4 strands using a (second) final twist (T2) varying from 150 to 300 t/m depending on the case concerned, corresponding to a twist factor K2 varying from 175 to 215 and to a direction D2 (direction S). In a conventional manner, each of these strands had previously been manufactured by a (first) initial twist (denoted T1) of 150 to 300 t/m, depending on the case concerned, of a yarn about itself in the opposite direction D1 (direction Z).

The 3 examples of cords according to the invention C8, C9 and C11 (also denoted “I” and shown in bold in Table 1) are characterized by a construction with a triple twist T1, T2, T3 (in these examples, Z/Z/S); they were manufactured by the assembly of 3 or 4 strands using a final twist (denoted T3) ranging from 150 to 300 t/m (K3 of 203 or 215) and a direction D2 (direction S). According to the invention, each of these strands had been previously manufactured by the assembly of 3 pre-strands with a twist T2 (110, 180 or 240 T/m) and an opposite direction D1 (direction Z), each of these pre-strands having itself been prepared in advance by a twist T1 (of 40, 120 or 60 t/m respectively) of a yarn about itself, in the direction D1 (direction Z).

As regards the 3 comparison examples (denoted “C” in Table 1) of cords C2, C4 and C6 not according to the invention, they are all characterized by a construction with a triple twist T1, T2, T3. Unlike the cords according to the invention, the constituent yarns of these cords were all nylon yarns, not aramid yarns.

It is important to note that all the cords in these examples, regardless of the material (nylon or aramid) and the count (47, 94, 140, 55 or 330 tex) of their initial yarns, are characterized by final twist factors (K2 or K3 respectively, depending on whether the cord has a construction with a double twist T1, T2 or with a triple twist T1, T2, T3) whose mean value is equal to about 195 (varying from 175 to 215).

From a detailed perusal of this Table 1, it will be noted, firstly, that for tests 1 to 3, all conducted with nylon yarns (Mi of about 440 cN/tex), that the change from double twist (C1, C3 and C5) to triple twist (C2, C4 and C6) is not accompanied by any notable modification in the breaking strength or the other properties (Ø, count, toughness).

Conversely, for tests 4 and 5, conducted with aramid yarns, more precisely Kevlar yarns of 55 tex or 330 tex (Mi of about 4000 cN/tex), it may be seen that the change from double twist construction (C7 and C10 respectively) to triple twist construction (respectively, C8 and C9 on the one hand, C11 on the other hand), everything else being equal, is unexpectedly accompanied by:
an improvement of 6% (cord C9) to 16% (cord C11) in breaking strength and 8% (cord C9) to 17% (cord C11) in toughness, which is highly significant to a person skilled in the art;
combined with a notable decrease in the apparent diameter Ø and the count, clear indicators of better compactness of the cords according to the invention and ultimately of the quality of these reinforcements, because of their very specific construction;
the final overall result being an increase ranging from 12% (cord C9) to 26% (cord C11) in apparent toughness.

To summarize, the invention therefore makes it possible, for the same given final twist, to improve the properties of compactness, breaking strength and toughness of the cords using yarns consisting of aromatic polyamide or aromatic copolyamide monofilaments.

Additionally, and most surprisingly, their novel construction imparts an endurance in compression or flexion and compression which is also notably an improvement, as attested by the following results of the endurance tests.

Tests of Endurance in Compression (“Disc Fatigue Test”) or in Flexion and Compression (“Shoe Shine Test”)

For cords intended, notably, for reinforcing tyre structures, the fatigue resistance may be analysed by subjecting these cords to various known laboratory tests, notably the fatigue test known by the name of the “belt” test, sometimes called the “Shoe Shine test”, or the fatigue test called the “Disc Fatigue Test” (see for example EP 848 767, U.S. Pat. Nos. 2,595,069, 4,902,774, and the ASTM D885-591 standard, revised 67T), in which tests the cords, previously coated, are incorporated into a rubber article that is cured.

The principle of the “belt” test, primarily, is as follows: the belt comprises two layers of textile filamentary elements, the first layer comprising the cords whose performance is to be evaluated, embedded at a pitch of 1.25 mm in two skims of compound, each measuring 0.4 mm, and a second stiffening layer for preventing the elongation of the first layer, this second layer comprising relatively rigid textile filamentary elements and comprising two aramid strands of 167 tex each, twisted together with a twist of 315 turns per metre and embedded at a pitch of 0.9 mm in two skims of compound, each measuring 0.3 mm. The axis of each cord is orientated in the longitudinal direction of the belt. This belt is then subjected to the following stresses: the belt is drawn cyclically around a roller of given diameter, using a crank and crankshaft system, in such a way that each elementary portion of the belt is subjected to a tension of 15 daN and undergoes cycles of variation of curvature causing it to pass from an infinite radius of curvature to a given radius of curvature in the course of 190,000 cycles, at a frequency of 7 Hz. This variation of curvature of the belt causes the cord on the inner layer, which is closer to the roller, to undergo a given rate of geometric compression depending on the diameter of the chosen roller. At the end of this stressing, the cords are extracted by stripping from the inner layer, and the residual breaking strength of the fatigued cords is measured.

The “Disc Fatigue Test” is another test well known to the person skilled in the art; it essentially consists in incorporating cords to be tested in blocks of rubber, and then, after curing, fatiguing the rubber test specimens formed in this way in compression between two rotating discs, over a very large number of cycles (600,000 cycles at 33 cycles/s in the following examples). After this fatigue, the cords are extracted from the test specimens and their residual breaking strength is measured.

Initially, cords C1 to C4 and C7, not according to the invention, and cords C8 and C9 according to the invention from the previous tests were subjected, on the one hand, to the “Disc Fatigue Test” with a maximum geometric compression rate of the test specimen of about 16% (with an angle of 3° between the two discs), and, on the other hand, to the “Shoe Shine test” with a geometric compression rate of the cord in the inner layer of about 12% (20 mm roller).

In both cases, the residual breaking strengths (Fr) shown as relative values in the appended Table 2 were measured in the cords extracted after fatigue. For both fatigue conditions, the base 100 was used for the residual breaking strength (Fr) measured in the control cords (“T”) with a double twist T1, T2. A value of more than 100 indicates an increased breaking strength, and therefore an improved endurance relative to the corresponding control.

From a detailed perusal of this Table 2, it will be noted, firstly, that for tests 1 and 2, conducted with nylon yarns, the change from double twist (C1 and C3 respectively) to triple twist (C2 and C4 respectively), regardless of the type of test (Disc Fatigue Test or Shoe Shine Test), is not accompanied by any notable modification, with allowance for the usual accuracy of these types of tests, or in any case by any improvement of the endurance in compression or in flexion and compression.

Conversely, for test 4, conducted with aramid yarns, it was found, surprisingly, that the change from double twist construction (cord C7) to triple twist construction (cords C8 and C9), everything else being equal, is unexpectedly accompanied by a very notable improvement (varying from 20% to 62% depending on the case concerned) in the residual breaking strength, for each of the two fatigue tests.

It should be noted, in particular, that in the case of cord C9 according to the invention, in which T2 is between 0.4 and 0.8 times (in this case, 0.6 times) T3, the endurance is even is further improved relative to cord C8 according to the invention, for which T2 does not conform to this relation.

The above tests were completed by a supplementary endurance test (test 6 in Table 2) conducted on two other cords, C12 (control) and C13 (invention), aramid-based as for the preceding test 4, both of these cords having a final twist factor (K2 or K3 respectively) identical (being equal to about 180) to those used for the nylon controls of the preceding tests 1 to 3.

In a similar manner to the constructions discussed above, the construction denoted “A55/-/3/3” of the control cord C12 signifies that this cord is a double-twist (T1, T2) cord produced simply by an operation of twisting (T2 of 310 t/m, D2 or S) of 3 different strands, each of which has been prepared in advance by an individual operation of reverse twisting (T1 of 310 t/m, D1 or Z) of 3 aramid (A) yarns with a count of 55 tex.

Comparatively, for the construction denoted “A55/1/3/3” of the cord C13 according to the invention, the cord concerned is a triple-twist (T1, T2, T3) cord produced by an operation of final twisting (T3 of 310 t/m, D2 or S) of 3 different strands, each of which has been prepared in advance by an intermediate operation of twisting (T2 of 185 t/m) in the reverse direction (D1 or Z) of 3 pre-strands, each of these pre-strands consisting of a 1 single aramid (A) yarn with a count of 55 tex, which has previously been twisted about itself in a first twisting operation T1 (125 t/m) in the same direction D1 (Z).

The results obtained were added to Table 2, and clearly confirm the superiority of the triple-twist cord C13 of the invention compared with the double-twist control cord C12, with a highly notable increase in the residual breaking strength for each of the two fatigue tests, this increase being particularly great for the belt test.

In conclusion, as a result of the invention, it is possible, for the same given final twist, to improve not only the properties of compactness, breaking strength and toughness of the cords using yarns consisting of aromatic polyamide or aromatic copolyamide monofilaments, but also their endurance in compression or flexion and compression, thus enabling a tyre comprising a single high-endurance working ply to be obtained.

Second Series of Tests

A comparison was made between five triple-twist cords having different constructions, not optimized according to the criteria of endurance in flexion and compression, diameter, and limitation of modifications to be made to existing twisting machinery, but conforming to the invention (cords E1, E2, E3), or optimized according to these criteria and conforming to the invention (cords E4 and 30).

The construction of each cord and its final properties are summarized in Table 3 below.

The initial yarns are, as is known, available commercially, in this case being sold by DuPont under the trade name Kevlar or by Teijin under the trade name Twaron.

For each cord, the breaking strength (Fr) and the apparent diameter (ø) were measured. The apparent toughness (σ) was deduced from these. The values of breaking strength and apparent toughness are also shown in base 100 relative to cord E1.

Also shown are the cord density and the lay-up pitch required to produce a ply whose calenderability factor varies from 4.8 to 4.9, these two values not differing significantly and corresponding to a ply that can be manufactured in existing industrial conditions and has correctly formed links of polymeric material between the adjacent cords. The calenderability factor is defined as the ratio between the diameter of the cord and the difference between the lay-up pitch in the ply and the diameter of the cord. For the proposed plies, the breaking strength of the ply (Rn), expressed in daN per mm of ply, was also calculated.

The endurance in flexion and compression was also evaluated in a similar manner to the first series of tests. Thus the test belt comprises two layers of textile filamentary elements, the first layer comprising the cords whose performance is to be evaluated, embedded at a pitch of 1.25 mm in two skims of compound, each measuring 0.4 mm, and a second stiffening layer for preventing the elongation of the first layer, this second layer comprising relatively rigid textile filamentary elements and comprising two aramid strands of 167 tex each, twisted together with a twist of 315 turns per metre and embedded at a pitch of 0.9 mm in two skims of compound, each measuring 0.3 mm. The axis of each cord is orientated in the longitudinal direction of the belt. This belt is then subjected to the following stresses: the belt is drawn cyclically around a roller of given diameter, using a crank and crankshaft system, in such a way that each elementary portion of the belt is subjected to a tension of 15 daN and undergoes cycles of variation of curvature causing it to pass from an infinite radius of curvature to a given radius of curvature, in this case 20 mm, in the course of 190,000 cycles, at a frequency of 7 Hz. This variation of curvature of the belt causes the cord on the inner layer, which is closer to the roller, to undergo a given rate of geometric compression depending on the diameter of the chosen roller. At the end of this stressing, the cords are extracted by stripping from the inner layer, and the residual breaking strength of the fatigued cords is measured. From this is deduced the residual apparent toughness (σ′) and the loss, expressed in %, of apparent toughness during the test. The greater the loss, the less satisfactory is the endurance of the cord.

The construction denoted “A55/1/3/4-Z120/Z180/S300” of the cord E1 signifies that this cord is a triple-twist (T1, T2, T3) cord produced by an operation of final twisting (T3=300 turns·m⁻¹, direction S) of 4 different strands, each of which has been prepared in advance by an operation of intermediate twisting (T2=180 turns·m⁻¹) in the reverse direction (direction Z) of 3 pre-strands, each of these 3 pre-strands consisting of a 1 single yarn consisting of is elementary monofilaments of aromatic polyamide, in this case the aramid (A) with a count of 55 tex that has previously been twisted about itself in a first twisting operation T1=120 turns·m⁻¹ in the same direction (direction Z) as for the pre-strands. The other notations of the cords E2 to E4 and 30 enable the constructions corresponding to these cords to be identified mutatis mutandis.

It is important to note that all the cords E1 to E4 and 30 are characterized by final twist factors K3 that are very similar and provide assurance that the superior properties of the optimized cords are due to the specific combination of the count of its yarns and the values of N and M, and not to other characteristics such as the twists T1, T2 and T3.

With the exception of cords E1 and 30, none of the tested cords is based on yarns consisting of elementary monofilaments of aromatic polyamide or aromatic copolyamide, having a count varying from 45 to 65 tex, in this case from 50 to 60 tex and equal to 55 tex. Cords E2 to E4 all have yarns with higher counts. Only the optimized cord 30 has a construction in which M=3 and N=3 and in which each yarn has a count ranging from 45 to 65 tex. Additionally, only cord 34, which is also optimized, has a construction in which M=2 and N=3 and in which each yarn has a count ranging from 90 to 130 tex, in this case from 100 to 120 tex and equal to 110 tex.

In fact, cord E1 has a construction in which M=3 and N=4, resulting in the best breaking strength Fr and the best apparent toughness a obtained among the tested cords. However, another effect of the M=3 and N=4 constructions is that, on the one hand, this cord becomes more costly to manufacture because it requires numerous modifications to the existing twisting machinery, and, on the other hand, it is necessary to use a relatively lengthy manufacturing process and numerous twisting machines simultaneously, since this cord is based on 12 yarns. Above all, the loss in cord E1 is greatest out of all the tested cords.

Cord E2 has a construction in which N=M=2. In an attempt to compensate for a relatively small number of yarns, cord E2 comprises yarns having a count of 167 tex. The N=M=2 construction of cord E2 enables it to be manufactured on the existing twisting machinery without modifying the machinery, while allowing the use of a method which is relatively fast and also requires a very low number of machines because of the very low number of yarns used for the cord (4 for cord E2, as against 12 for cord E1). However, the use of a relatively high count results, on the one hand, in the lowest apparent toughness a among the tested cords, and, on the other hand, in a relatively large diameter and therefore a relatively low ply breaking strength Rn. Furthermore, the loss in cord E2 is relatively high.

Cord E3 has a construction in which M=2 and N=3, enabling the count of each yarn to be reduced by comparison with cord E2. The M=2 and N=3 construction of cord E3 enables it to be manufactured on the existing twisting machinery without modifying the machinery, while allowing the use of a method which is relatively fast and also requires a low number of machines because of the low number of yarns used for the cord (6 for cord E3, as against 12 for cord E1). Thus cord E3 has a relatively small diameter, but at the cost of a lower apparent toughness a than cord E1 and a ply strength Rn comparable to that of cord E2, that is to say relatively low. Furthermore, the loss in cord E3 is relatively high.

Cord E4 has a construction in which M=2 and N=3, enabling the count of each yarn to be reduced relative to cord E2 and to be increased relative to cord E1. As for cord E3, the M=2 and N=3 construction of cord E4 enables it to be manufactured on the existing twisting machinery without modifying the machinery, while allowing the use of a method which is relatively fast and also requires a low number of machines because of the low number of yarns used for the cord (6 for cord E4, as against 12 for cord E1). Thus cord E4 has a larger diameter than that of cord E3, equivalent to cord E1. However, because of a higher breaking strength Fr than those of cords E2 and E3, the ply incorporating cord E4 has a higher ply breaking strength Rn than the plies incorporating cords E2 and E3. By contrast with cords E1, E2 and E3, cord E4 shows a greatly reduced loss. Although it has a larger diameter than that of cord 30, cord E4 represents a very useful compromise between smaller diameter, improved endurance and ease of manufacture.

Finally, the optimized cord 30 represents the best compromise between smaller diameter, improved endurance and ease of manufacture. This is because, by contrast with cord E1, the construction of the optimized cord 30 is such that M=N=3, enabling it to be manufactured on the existing twisting machinery without modifying the machinery, while allowing the use of a method which is relatively fast and also requires a low number of machines because of the low number of yarns used for the cord (9 for the optimized cord 30, as against 12 for cord E1). By contrast with cords E2 and E4, the diameter of the optimized cord 30 is smaller than that of cord E1. Such a diameter makes it possible to reduce the ply thicknesses and the hysteresis of the tyre, and therefore the rolling resistance of the tyre. Also, owing to the reduced diameter, by contrast with cords E2, E3 and E4, the optimized cord 30 shows an apparent toughness equivalent to that of cord E1. Furthermore, by contrast with cords E2 and E3, the ply breaking strength Rn is kept at a satisfactory level relative to cord E1. Above all, the optimized cord 30 shows a much better endurance than that of cords E1, E2 and E3.

In conclusion, because of this optimization, it is now possible, for the same given final twist, to improve not only the properties of compactness and endurance in flexion and compression, and to improve further the architecture of the tyres to be reinforced with these cords, without the need to make numerous modifications to the existing manufacturing machinery, while also using a method which is relatively fast and does not require an excessively large number of machines, owing to the modest number of yarns on which the cord is based.

TABLE 1

| | | | | | | | | | | Mechanical properties | | | | | | | |
|---|---|---|---|---|---|---|---|---|---|---|---|---|---|---|---|---|---|
| | | | | Twists t/m | | | Twist factor | | | Breaking | | Ø | | | | Apparent | |
| No. | Ref. of | Nature of | Construction | — | T1 | T2 | — | K1 | K2 | strength | | apparent | Count | Toughness | | toughness | |
| Test | Cord | Cord | of the Cord | T1 | T2 | T3 | K1 | K2 | K3 | daN | | mm | tex | cN/tex | | daN/mm² | |
| 1 | C1 | T | N47/—/3/4 | 0 | 250Z | 250S | 0 | 88 | 176 | 35.3 | 100 | 1.05 | 638 | 55 | 100 | 41 | 100 |
| | C2 | C | N47/1/3/4 | 100Z | 150Z | 250S | 20 | 53 | 176 | 34.1 | 97 | 1.02 | 642 | 53 | 96 | 42 | 102 |
| 2 | C3 | T | N94/—/2/3 | 0 | 260Z | 260S | 0 | 106 | 183 | 41.2 | 100 | 1.03 | 636 | 65 | 100 | 50 | 100 |
| | C4 | C | N94/1/2/3 | 100Z | 160Z | 260S | 29 | 65 | 183 | 42.3 | 103 | 1.04 | 640 | 66 | 102 | 50 | 100 |
| 3 | C5 | T | N140/—/2/2 | 0 | 250Z | 250S | 0 | 124 | 175 | 44.5 | 100 | 1.02 | 613 | 73 | 100 | 54 | 100 |
| | C6 | C | N140/1/2/2 | 100Z | 150Z | 250S | 35 | 74 | 175 | 43.5 | 98 | 1.03 | 608 | 72 | 99 | 52 | 96 |
| 4 | C7 | T | A55/—/3/4 | 0 | 300Z | 300S | 0 | 102 | 203 | 110.6 | 100 | 1.07 | 777 | 142 | 100 | 122 | 100 |
| | C8 | I | A55/1/3/4 | 60Z | 240Z | 300S | 12 | 81 | 203 | 119.4 | 108 | 1.03 | 764 | 156 | 110 | 143 | 117 |
| | C9 | I | A55/1/3/4 | 120Z | 180Z | 300S | 23 | 61 | 203 | 116.9 | 106 | 1.04 | 765 | 153 | 108 | 137 | 112 |
| 5 | C10 | T | A330/—/3/3 | 0 | 150Z | 150S | 0 | 124 | 215 | 404.2 | 100 | 2.48 | 3,482 | 116 | 100 | 84 | 100 |
| | C11 | I | A330/1/3/3 | 40Z | 110Z | 150S | 19 | 91 | 215 | 467.8 | 116 | 2.37 | 3,428 | 136 | 117 | 106 | 126 |

TABLE 2

| | | | | | | | | | | “Disc | “Shoe |
|---|---|---|---|---|---|---|---|---|---|---|---|
| | | | | Twists t/m | | | Twist factor | | | Fatigue | Shine |
| No. | Ref. of | Nature of | Construction | — | T1 | T2 | — | K1 | K2 | Test” | Test” |
| Test | Cord | Cord | of the Cord | T1 | T2 | T3 | K1 | K2 | K3 | Residual Fr | Residual Fr |
| 1 | C1 | T | N47/—/3/4 | 0 | 250Z | 250S | 0 | 88 | 176 | 100 | 100 |
| | C2 | C | N47/1/3/4 | 100Z | 150Z | 250S | 20 | 53 | 176 | 95 | 97 |
| 2 | C3 | T | N94/—/2/3 | 0 | 260Z | 260S | 0 | 106 | 183 | 100 | 100 |
| | C4 | C | N94/1/2/3 | 100Z | 160Z | 260S | 29 | 65 | 183 | 97 | 99 |
| 4 | C7 | T | A55/—/3/4 | 0 | 300Z | 300S | 0 | 102 | 203 | 100 | 100 |
| | C8 | I | A55/1/3/4 | 60Z | 240Z | 300S | 12 | 81 | 203 | 120 | 136 |
| | C9 | I | A55/1/3/4 | 120Z | 180Z | 300S | 23 | 61 | 203 | 125 | 162 |
| 6 | C12 | T | A55/—/3/3 | 0 | 310Z | 310S | 0 | 105 | 182 | 100 | 100 |
| | C13 | I | A55/1/3/3 | 125Z | 185Z | 310S | 24 | 63 | 182 | 111 | 193 |

TABLE 3

| | E1 | E2 | E3 | E4 | 30 |
|---|---|---|---|---|---|
| | A55/1/3/4 | A167/1/2/2 | A84/1/2/3 | A110/1/2/3 | A55/1/3/3 |
| Name | Z120/Z180/S300 | Z120/Z180/S300 | Z120/Z180/S300 | Z120/Z180/S300 | Z140/Z200/S340 |
| Count of each yarn | 55 | 167 | 84 | 110 | 55 |
| M | 3 | 2 | 2 | 2 | 3 |
| N | 4 | 2 | 3 | 3 | 3 |
| T1 (turns · m⁻¹) | 120 | 120 | 120 | 120 | 140 |
| T2 (turns; m⁻¹) | 180 | 180 | 180 | 180 | 200 |
| T3 (turns; m⁻¹) | 300 | 300 | 340 | 300 | 340 |
| K1 | 23 | 41 | 29 | 33 | 27 |
| K2 | 61 | 87 | 61 | 70 | 68 |
| K3 | 203 | 204 | 201 | 203 | 199 |
| Fr (daN) | 116.5 | 88.1 | 73.7 | 99.7 | 87.0 |
| Fr (base 100) | 100 | 76 | 63 | 86 | 75 |
| Diameter Ø (mm) | 0.96 | 1.01 | 0.84 | 0.97 | 0.84 |
| σ (daN/mm2) | 161 | 110 | 133 | 135 | 157 |
| σ (base 100) | 100 | 68 | 83 | 84 | 98 |
| Density (cords/dm) | 86 | 81 | 99 | 86 | 98 |
| Laying pitch (mm) | 1.16 | 1.22 | 1.01 | 1.17 | 1.01 |
| Calenderability factor | 4.8 | 4.8 | 4.9 | 4.9 | 4.9 |
| Rn (daN/mm) | 100.4 | 72.2 | 72.9 | 85.2 | 86.1 |
| σ′ (daN/mm2) | 90 | 65 | 82 | 90 | 109 |
| Drop-off (%) | 44 | 41 | 38 | 33 | 31 |

1.-15. (canceled)

16. A tire comprising a crown comprising a tread, two sidewalls and two beads, each sidewall connecting each bead to the crown, a crown reinforcement extending in the crown in a circumferential direction of the tire, the crown reinforcement comprising a hoop reinforcement comprising a single hooping ply comprising at least one hooping reinforcing textile filamentary element forming an angle that is strictly less than 10° with the circumferential direction of the tire, a carcass reinforcement anchored in each of the beads and extending in the sidewalls and in the crown, the crown reinforcement being radially interposed between the carcass reinforcement and the tread,
wherein the carcass reinforcement comprises a single carcass ply, the single carcass ply comprising carcass reinforcing filamentary elements,
wherein the crown reinforcement comprises a working reinforcement comprising a single working ply, and the single working ply comprises working reinforcing filamentary elements,
wherein the hooping reinforcing textile filamentary element or elements, the working reinforcing filamentary elements and the carcass reinforcing filamentary elements are arranged so as to form a triangular mesh in projection on a circumferential equatorial plane,
wherein the or each hooping reinforcing textile filamentary element is formed by a cord with a triple twist and comprises an assembly consisting of N>1 strands twisted together with a twist T3 in a direction D2, each strand consisting of M>1 pre-strands which are themselves twisted together with a twist T2 in a direction D1 opposite to D2, and each pre-strand itself consisting in a yarn that is twisted about itself with a twist T1 in the direction D1, and
wherein at least half of the N times M yarns consist of elementary monofilaments of aromatic polyamide or aromatic copolyamide.

17. The tire according to claim 16, wherein each yarn consists of elementary monofilaments of aromatic polyamide or aromatic copolyamide.

18. The tire according to claim 16, wherein N ranges from 2 to 6.

19. The tire according to claim 16, wherein M ranges from 2 to 6.

20. The tire according to claim 16, wherein the twist T1 expressed in turns per meter ranges from 10 to 350.

21. The tire according to claim 16, wherein each pre-strand has a twist factor K1 ranging from 2 to 80.

22. The tire according to claim 16, wherein the twist T2 expressed in turns per meter ranges from 25 to 470.

23. The tire according to claim 16, wherein each strand has a twist factor K2 ranging from 10 to 150.

24. The tire according to claim 16, wherein the twist T3 expressed in turns per meter ranges from 30 to 600.

25. The tire according to claim 16, wherein each strand has a twist factor K3 ranging from 50 to 500.

26. The tire according to claim 16, wherein T2 is greater than T1.

27. The tire according to claim 16, wherein T3 is greater than T2.

28. The tire according to claim 16, wherein a sum T1+T2 ranges from 0.8 times T3 to 1.2 times T3.

29. The tire according to claim 16, wherein each carcass reinforcing filamentary element forms an angle A_{C1} greater than or equal to 55° with the circumferential direction of the tire in a median plane of the tire.

30. The tire according to claim 16, wherein each carcass reinforcing filamentary element forms an angle A_{C2} greater than or equal to 85° with the circumferential direction of the tire in the circumferential equatorial plane of the tire.
